(19) United States
(12) Patent Application Publication
(10) Pub. No.: US 2024/0294246 A1
(43) Pub. Date: Sep. 5, 2024

(54) ROTOR SPINDLE ASSEMBLY WITH TAPERED INTERFERENCE JOINT

(71) Applicant: Textron Innovations Inc., Providence, RI (US)

(72) Inventors: Ken Shundo, Fort Worth, TX (US); Ryan Smith, Fort Worth, TX (US); Bryan Baskin, Arlington, TX (US); Hassan Mughal, Frisco, TX (US)

(73) Assignee: Textron Innovations Inc., Providence, RI (US)

(21) Appl. No.: 18/176,899

(22) Filed: Mar. 1, 2023

(51) Int. Cl. B64C 11/06; B64C 29/00

(52) U.S. Cl. CPC B64C 11/06; B64C 29/0033

(57) ABSTRACT

A spindle bearing assembly for a rotor blade, the assembly having a shaft extending from a hub and a housing for coupling the blade to the shaft. A ring is coaxial with the shaft and has a wall with a tapered external surface that narrows toward the outboard direction. The ring can be axially translated adjacent a tapered internal surface of the housing that also narrows toward the outboard direction. A spindle bearing coaxial with the shaft has a central aperture through which the shaft extends, the spindle bearing extending between the wall and the shaft. Threaded fasteners couple the ring to the housing, and rotation of the fasteners in a selected direction causes axial translation of the ring in the outboard direction, the engagement of the tapered surfaces causing the wall to move radially inward for creating an interference fit between the spindle bearing and the wall.

### STATEMENT REGARDING FEDERALLY SPONSORED RESEARCH OR DEVELOPMENT

This invention was made with U.S. Government support under Agreement No. W9124P-19-9-0001 awarded by the Army Contracting Command-Redstone Arsenal to the AMTC and a related AMTC Project Agreement 19-08-006 with Bell Textron Inc. The Government has certain rights in the invention.

### CROSS-REFERENCE TO RELATED APPLICATIONS

Not applicable.

### BACKGROUND

Elastomers are used in a variety of aircraft components to provide resilient reacting of forces. While elastomers are able to be widely used in multiple types of applications, some applications prevent their use due to various assembly or environmental conditions. For example, vulcanized or conventionally bonded elastomer components can be simple and inexpensive, but temperatures exceeding a certain threshold during assembly or operation may cause bonds to weaken or fail, requiring an alternative design for these components.

### BRIEF DESCRIPTION OF THE DRAWINGS

FIG. 1 is an oblique view of a tiltrotor aircraft according to this disclosure, the aircraft being shown in helicopter mode.

FIG. 2 is an oblique view of the aircraft of FIG. 1, the aircraft being shown in airplane mode.

FIG. 3 is an oblique view of a portion of a rotor assembly of the aircraft of FIG. 1 and showing a spindle assembly according to this disclosure.

FIG. 4 is a partially sectioned side view of a prior-art spindle assembly.

FIG. 5 is a sectioned side view of the spindle assembly of FIG. 3.

FIG. 6 is an enlarged view of a portion of the view of FIG. 5.

FIG. 7 is an oblique exploded view of the spindle assembly of FIG. 3.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure divulges an improved spindle assembly used for attaching blades to a hub of a rotor assembly. The assembly provides for a mechanical interference feature between two highly critical elastomer joints in the rotor system, in which a conventional thermal-fit joint cannot be used due to the presence of temperature-limited elastomers.

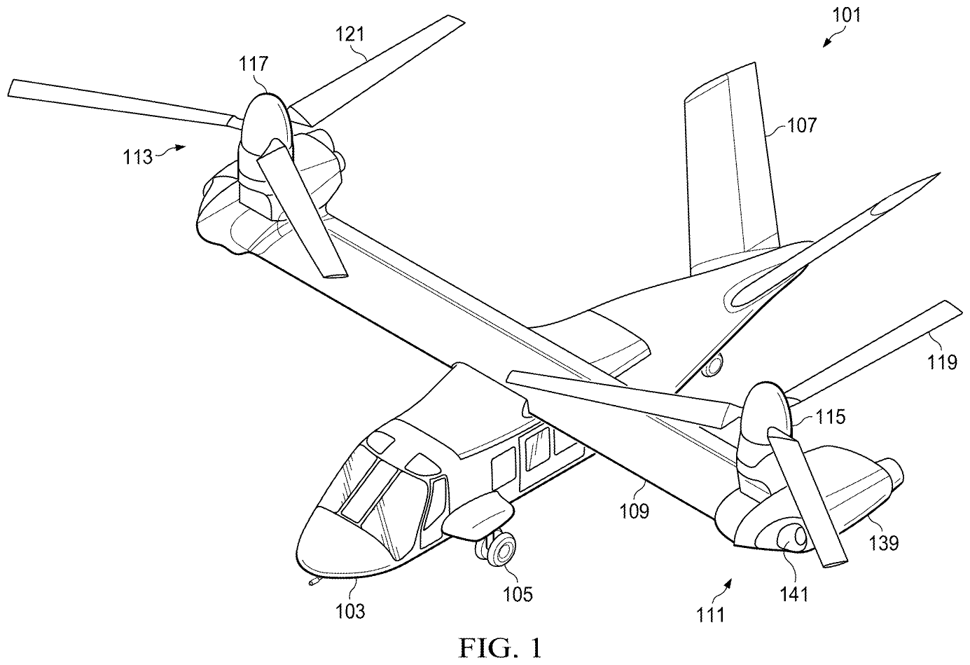

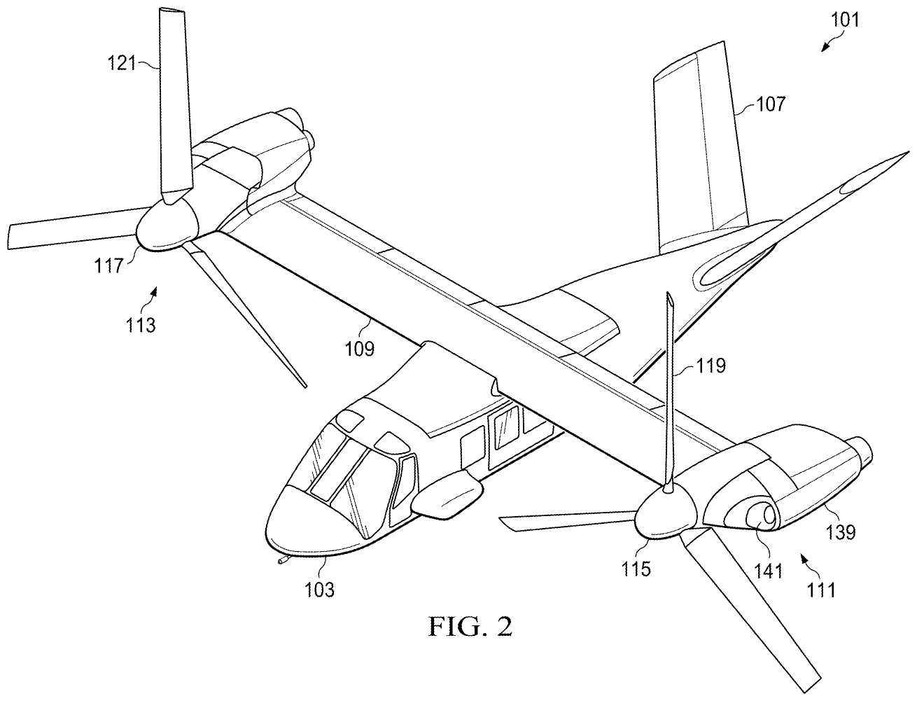

FIGS. 1 and 2 in the drawings illustrate a tiltrotor aircraft 101 according to the disclosure. Aircraft 101 includes a fuselage 103, a landing gear 105, a tail member 107, a wing 109, a drive system 111, and a drive system 113. Each drive system 111 and 113 includes a fixed engine 139 and a rotatable proprotor 115 and 117, respectively. Each of rotatable proprotors 115 and 117 has a plurality of rotor blades 119 and 121, respectively, associated therewith. The position of proprotors 115 and 117, as well as the pitch of rotor blades 119 and 121, can be selectively controlled in order to selectively control direction, thrust, and lift of aircraft 101.

FIG. 1 illustrates aircraft 101 in helicopter mode, in which proprotors 115 and 117 are positioned substantially vertical to provide a lifting thrust. FIG. 2 illustrates aircraft 101 in an airplane mode in which proprotors 115 and 117 are positioned substantially horizontal to provide a forward thrust in which a lifting force is supplied by wing 109. It should be appreciated that aircraft 101 can be operated such that proprotors 115 and 117 are selectively positioned between airplane mode and helicopter mode, which can be referred to as a conversion mode.

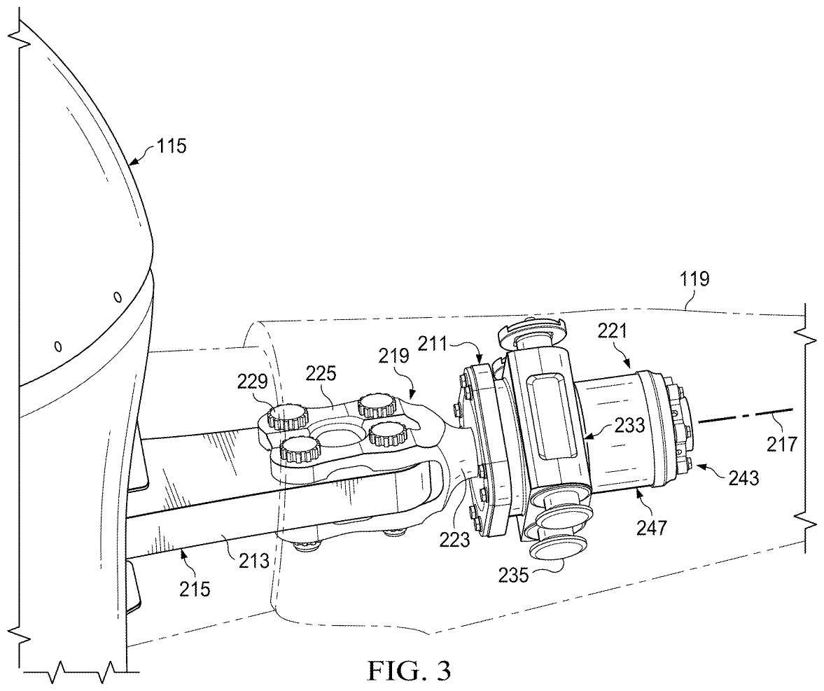

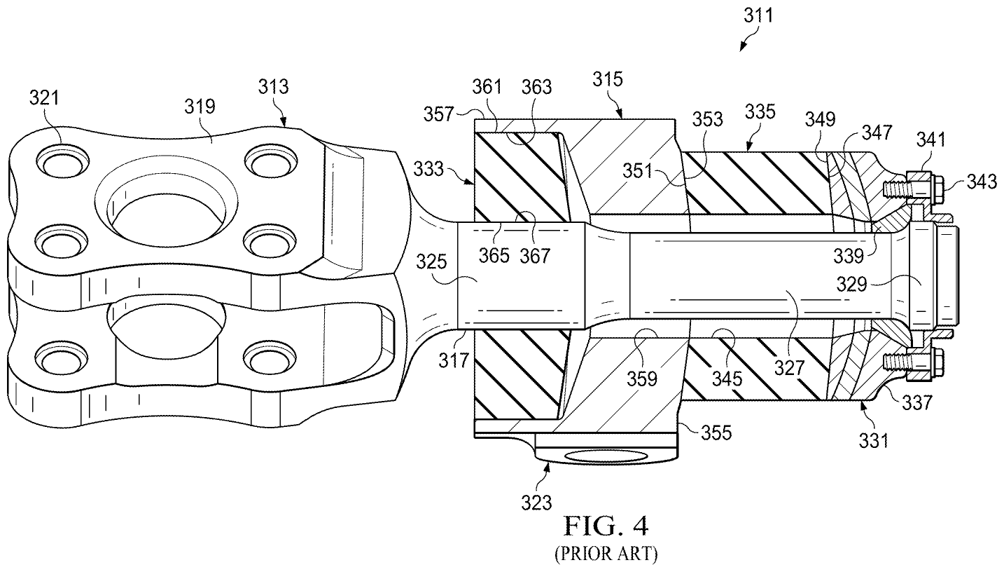

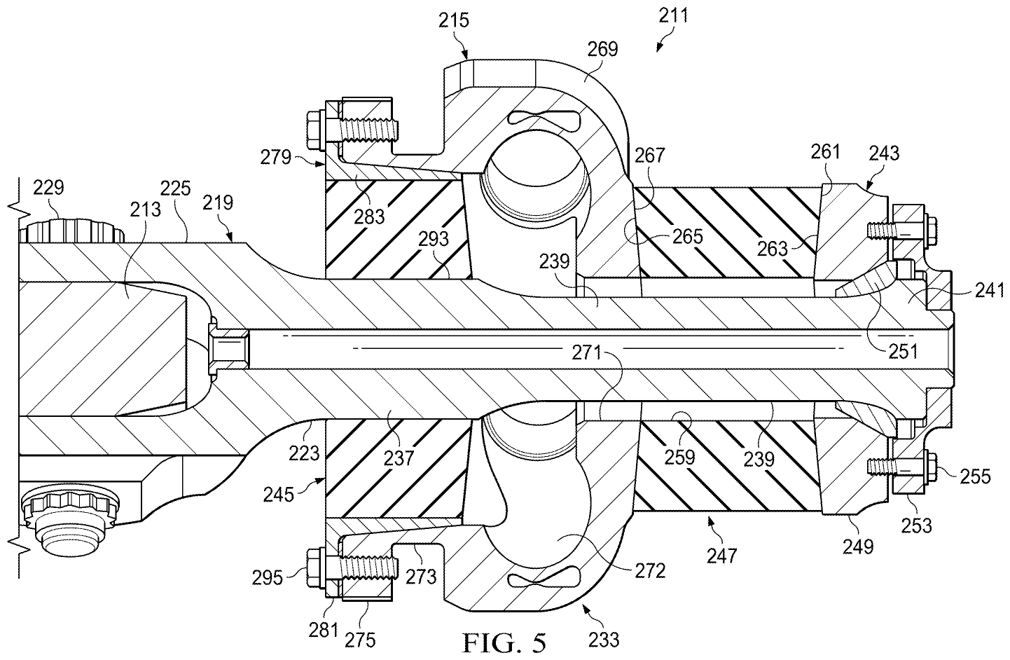

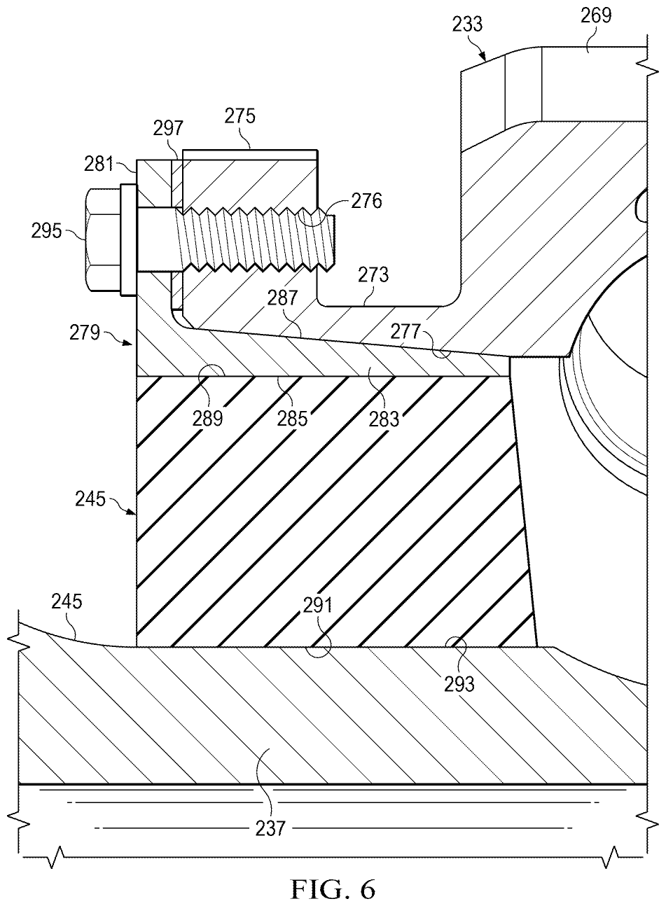

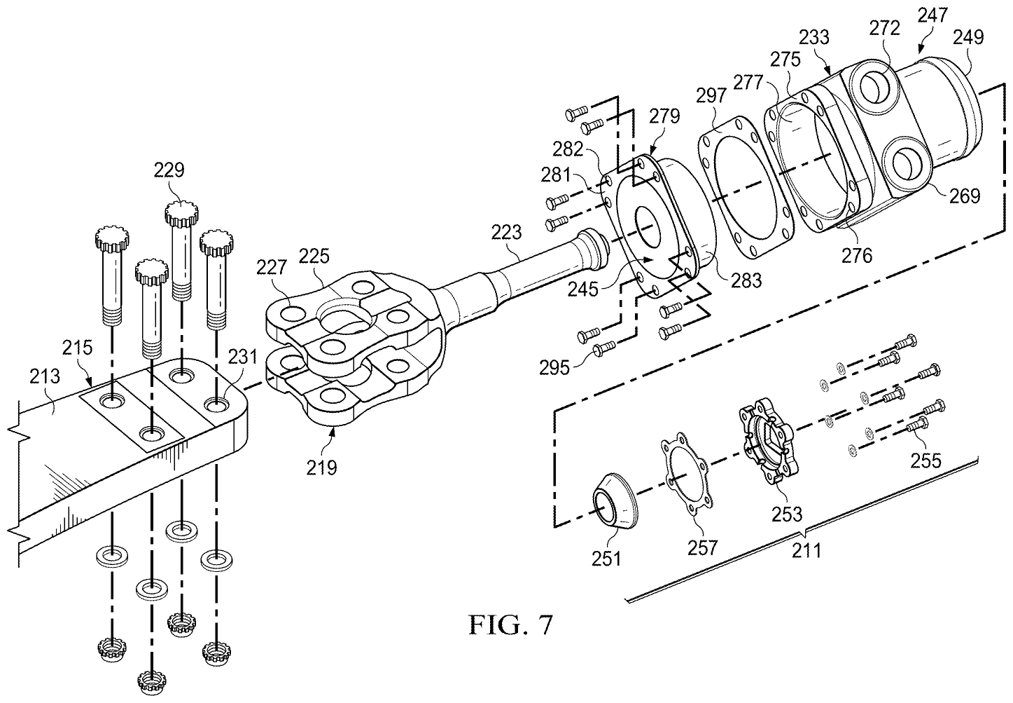

FIGS. 3 and 5 through 7 illustrate an improved spindle assembly 211 according this disclosure, whereas FIG. 4 illustrates a prior-art spindle assembly 311. As shown in FIG. 3, each assembly 211 is used to couple one of blades 119 to an outboard end portion of an arm 213 of yoke 215 of proprotor 115, and assembly 211 allows for limited rotation of the associated blade 119 relative to arm 213 about pitch axis 217. Though not shown, assemblies 211 are also used to couple each blade 121 to the arms of a yoke of proprotor 117, and the descriptions for proprotor 115 are equally applicable to proprotor 117.

Assembly 211 comprises a rigid spindle 219 and a bearing assembly 221 retained on a shaft 223 of spindle 219. Shaft 223 extends from an inboard clevis 225 configured for receiving the outboard end portion of arm 213, and clevis 225 has apertures 227 for receiving fasteners 229 that pass through apertures 231 of arm 213 for fixedly retaining spindle 219 on arm 213. Blade 119 is coupled to a housing 233 of bearing assembly 221 with fasteners 235, and forces are thereby transferred between yoke 215 and blade 119 through spindle assembly 211.

FIG. 4 is a partially sectioned side view of prior-art spindle assembly 311. Assembly 311 comprises a rigid spindle 313 and a bearing assembly 315 retained on a shaft 317 of spindle 313. Spindle assembly 311 has interface features for yoke arm 213 and blade 119 similar or identical to spindle assembly 211, allowing assembly 211 to be used in applications originally designed to use assembly 311.

Shaft 317 extends from an inboard clevis 319 configured for receiving the outboard end portion of arm 213, and clevis 319 has apertures 321 for receiving fasteners that pass through apertures 231 of arm 213 for fixedly retaining spindle 313 on arm 213. Blade 119 is coupled to housing 323 of bearing assembly 315 with fasteners (not shown), and forces are thereby transferred between yoke 215 and blade 119 through spindle assembly 311. Shaft 317 has a stepped profile, with an inboard portion 325 having a diameter larger than an outboard portion 327, and terminates at the outboard end in a bell-shaped section 329 that interfaces with cap assembly 331 to retain bearing assembly 315 on shaft 317 and react centrifugal forces from blade 119.

Bearing assembly 315 comprises an elastomer spindle bearing 333, which is carried within an inboard portion of housing 323, and an elastomer centrifugal-force (CF) bearing 335, which extends between an outboard end of housing 323 and cap assembly 331. Cap assembly 331 comprises a bearing base 337, a conical retainer 339, and a cap 341. Retainer 339 is configured to engage bell-shaped section 329 of shaft 317, and bearing base 337 engages retainer 339, thereby retaining base 337 on shaft 317 and allowing transfer of centrifugal forces from blade 119 through housing 323, CF bearing 335, and base 337 to shaft 317. Cap 341 is retained adjacent base 337 and retainer 339 with fasteners 343, thereby fixedly mounting cap assembly 331 on shaft 317.

CF bearing 335 is a hollow elastomer cylinder with an inner surface 345 having a diameter larger than the outer diameter of outboard portion 327 of shaft 317, such that no part of CF bearing 335 directly contacts shaft 317. An outboard end surface 347 is bonded to inboard surface 349 of base 337, and an inboard end surface 351 is bonded to an outboard surface 353 of housing 323.

Housing 315 is formed from a rigid material and has an outboard body 355 that has a generally square periphery and a cylindrical aperture 359 coaxial with shaft 317. An inboard cylindrical wall 357 extends from body 355, thereby forming a bearing pocket for receiving spindle bearing 333. Aperture 359 has a diameter larger than the outer diameter of outboard portion 327 of shaft 317, such that no part of housing 315 directly contacts shaft 317.

Spindle bearing 333 is a hollow elastomer cylinder with an outer surface 361 having a diameter approximately equal to an inner surface 363 of wall 357. An inner surface 365 of bearing 333 has a diameter equal to an outer surface 367 of inboard portion 325 of shaft 317 when installed. Outer surface 361 of bearing 333 is structurally bonded to inner surface 363 of wall 357, whereas inner surface 365 of bearing 333 is vulcanized to outer surface 367 of shaft 317. Spindle bearing 333 cooperates with cap assembly 331 to react in-plane and out-of-plane forces and to limit motions of bearing assembly 315 relative to spindle 313 other than rotation about pitch axis 217 through shearing deformation of bearing 333.

While offering an effective design for the application, the bonding of spindle bearing 333 to wall 357 in bearing assembly 315 is unable to accommodate the heat encountered during operation, leading to weakening and failure of the bond. Bearing assemblies having other designs, such as threaded couplings, are successfully used on aircraft but are too large for the present application.

Referring again to FIGS. 3 and 5 through 7, spindle assembly 211 has components similar to spindle assembly 311.

Shaft 223 has a stepped profile, with an inboard portion 237 having a diameter larger than an outboard portion 239, and terminates at the outboard end in a bell-shaped section 241 that interfaces with cap assembly 243 to retain bearing assembly 215 on shaft 223 and react centrifugal forces from blade 119.

Bearing assembly 215 comprises an elastomer spindle bearing 245, which is carried within an inboard portion of housing 233, and an elastomer centrifugal-force (CF) bearing 247, which extends between an outboard end of housing 233 and cap assembly 243. Cap assembly 243 comprises a bearing base 249, a conical retainer 251, and a cap 253. Retainer 251 is configured to engage bell-shaped section 241 of shaft 223, and bearing base 249 engages retainer 251, thereby retaining base 249 on shaft 223 and allowing transfer of centrifugal forces from blade 119 through housing 233, CF bearing 247, and base 249 to shaft 223. Cap 253 is retained adjacent base 249 and retainer 251 with fasteners 255, thereby fixedly mounting cap assembly 243 on shaft 223. A gasket 257 is located between cap 253 and base 249.

CF bearing 247 is a hollow elastomer cylinder with an inner surface 259 having a diameter larger than the outer diameter of outboard portion 239 of shaft 223, such that no part of CF bearing 247 directly contacts shaft 223. An outboard end surface 261 is bonded to inboard surface 263 of base 249, and an inboard end surface 265 is bonded to an outboard surface 267 of housing 233. As shown, surfaces 261, 263, 265, 267 may by spherical or otherwise curved.

Housing 233 is formed from a rigid material and has an outboard body 269 that has a generally square periphery and a cylindrical aperture 271 coaxial with shaft 223. Body comprises apertures 272 for receiving fasteners 235. An inboard wall 273 extends from body 269 and terminates in a generally square flange 275 having an array of threaded apertures 276. Conical inner surface 277 extends for the axial length of both wall 273 and flange 275, inner surface 277 being coaxial with shaft 223. Surface 277 is tapered so that the outboard diameter is smaller than the inboard diameter, and surface 277 forms a bearing pocket for receiving spindle bearing 245. Aperture 271 has a diameter larger than the outer diameter of outboard portion 239 of shaft 223, such that no part of housing 233 directly contacts shaft 223.

Spindle bearing 245 is a hollow elastomer cylinder carried within wedge ring 279. Ring 279 comprises a generally square flange 281, which is approximately the same size as flange 275 of housing 233 and has an array of apertures 282 configured to align with threaded apertures 276 or flange 275 of housing 233. A wall 283 extends outboard from an inner portion of flange 281, wall 283 being a hollow frustum with a cylindrical inner surface 285 and a conical outer surface 287. Outer surface 287 has a taper matching that of inner surface 277 of housing 233. An outer cylindrical surface 289 of bearing 245 has a diameter approximately equal to the diameter of inner surface 285 of wall 283, and surface 289 is vulcanized to surface 285. An inner surface 291 of bearing 245 has a diameter approximately equal to an outer surface 293 of inboard portion 237 of shaft 223, and surface 291 is vulcanized to surface 293. When ring 279 and housing 233 are assembled together, threaded fasteners 295 extend through flange 281 and engage threads within threaded apertures 276 of flange 275. A shim 297 may be used between flanges 275, 281, as described below. Spindle bearing 245 cooperates with cap assembly 243 to react in-plane and out-of-plane forces and to limit motions of bearing assembly 215 relative to spindle 219 other than rotation about pitch axis 217 through shearing deformation of bearing 245.

The matching tapers of inner surface 277 of housing 233 and outer surface 287 of wedge ring 279 provide a male/female mating relationship for creating an interference fit for spindle bearing 245 between inner surface 285 of ring 279 and outer surface 293 of inboard portion 237 of shaft 223. As fasteners 295 are tightened, flange 281 of ring 279 is drawn toward flange 275. When further tightened after surfaces 277, 287 are in contact, surface 277 forces wall 283 radially inward, compressing bearing 245 between surfaces 285, 293 and forming an interference fit. The amount of interference can be controlled by maintaining a selected gap between flanges 275, 281 when fasteners 295 draw flanges 275, 281 toward each other, and the assembly will react radial and torque loads like a conventional assembly using a straight-walled thermal-interference fit. The interference can be measured and controlled, and this is accomplished by: 1) assembling the components so that there is contact of tapered surfaces 277, 287; 2) measuring the gap between flanges 275, 281; and 3) prior to tightening of the fasteners, installing shims 297 between flanges 275, 281 to obtain a desired final gap between flanges 275, 281.

Spindle assembly 211 provides for several advantages over previous designs. The use of fasteners 295 to assemble wedge ring 279 and housing 233 allows for assembly 211 to be configured as a right-hand or left-hand version by installing housing 233 in either of two positions 90 degrees apart, providing for interchangeability between left- and right-handed proprotors 115, 117. The interchangeability of the assembly, as well as the improved maintenance facilitated by the discreet tapered joint, has a significant logistical improvement in terms of part availability and expended cost. The joint is also designed to make the assembly maintainable (inspection, assembly, disassembly) at the closest depot-level shop to flight operations, thereby improving fleet readiness. Spindle bearing 245 can be easily replaced, whereas pervious bonded designs required returning the assembly to the manufacturer for service.

Assembly 211 also provides for a minimum-volume design that will react the required loads, especially when replacing a bonded joint. Tapered joints are often used to react overturning moments, but assembly 211 is used to react torsion and radial shear loads, and a very shallow taper angle and preloading bearing 245 provides for high friction to carry torsional loads and interference to carry radial loads without fasteners 295 being the primary load path.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A spindle bearing assembly for a blade of an aircraft rotor, the assembly comprising:
a shaft extending from a hub of a rotor;
a housing adapted for coupling a blade to the shaft;
a ring coaxial with the shaft and having a wall with a tapered external surface that narrows toward the outboard direction, the ring configured to be axially translated adjacent a tapered internal surface of an inboard portion of the housing that also narrows toward the outboard direction; and
a spindle bearing coaxial with the shaft and having a central aperture through which the shaft extends, the spindle bearing extending between the wall and the shaft;
wherein threaded fasteners couple the ring to the housing, and rotation of the fasteners in a selected direction cause axial translation of the ring in the outboard direction, the engagement of the tapered surfaces causing the wall to move radially inward for creating an interference fit between the spindle bearing and the wall.

2. The assembly of claim 1, wherein:
the ring and housing each comprise a flange; and
the fasteners couple the housing and ring using the flanges.

3. The assembly of claim 2, further comprising:
at least one shim located between the flanges for maintaining a selected distance between the flanges when the fasteners are tightened.

4. The assembly of claim 1, wherein:
axial translation of the ring in the outboard direction preloads the spindle bearing.

5. The assembly of claim 1, wherein:
the spindle bearing is vulcanized to the shaft.

6. The assembly of claim 1, wherein:
the spindle bearing is vulcanized to the wall.

7. The assembly of claim 1, further comprising:
a centrifugal force bearing coupling the housing to the shaft.

8. A spindle assembly for coupling a blade to an aircraft rotor, the assembly comprising:
a shaft adapted to be coupled at an inboard portion to a hub of a rotor;
a centrifugal force bearing coupled to an outboard portion of the shaft;
a housing adapted for coupling a blade to the centrifugal force bearing;
a ring coaxial with the shaft and having a wall with a tapered external surface that narrows toward the outboard direction, the ring configured to be axially translated adjacent a tapered internal surface of an inboard portion of the housing that also narrows toward the outboard direction; and
a spindle bearing coaxial with the shaft and having a central aperture through which the shaft extends, the spindle bearing extending between the wall and the shaft;
wherein threaded fasteners couple the ring to the housing, and rotation of the fasteners in a selected direction cause axial translation of the ring in the outboard direction, the engagement of the tapered surfaces causing the wall to move radially inward for creating an interference fit between the spindle bearing and the wall.

9. The assembly of claim 8, wherein:
the ring and housing each comprise a flange; and
the fasteners couple the housing and ring using the flanges.

10. The assembly of claim 9, further comprising:
at least one shim located between the flanges for maintaining a selected distance between the flanges when the fasteners are tightened.

11. The assembly of claim 8, wherein:
axial translation of the ring in the outboard direction preloads the spindle bearing.

12. The assembly of claim 8, wherein:
the spindle bearing is vulcanized to the shaft.

13. The assembly of claim 8, wherein:
the spindle bearing is vulcanized to the wall.

14. A method of preloading a spindle bearing of a spindle assembly, the method comprising:
(a) providing a shaft extending from a hub of a rotor and a housing adapted for coupling a blade to the shaft;
(b) providing a ring coaxial with the shaft and having a wall with a tapered external surface that narrows toward the outboard direction, the ring configured to be axially translated adjacent a tapered internal surface of an inboard portion of the housing that also narrows toward the outboard direction;
(c) providing a spindle bearing coaxial with the shaft and having a central aperture through which the shaft extends, the spindle bearing extending between the wall and the shaft;
(d) rotating in a selected direction threaded fasteners coupling the ring to the housing for causing axial translation of the ring in the outboard direction, the engagement of the tapered surfaces causing the wall to move radially inward for creating an interference fit between the spindle bearing and the wall and preloading the spindle bearing.

15. The method of claim 14, wherein:
in step (a), providing a flange on the housing;
in step (b), providing a flange on the ring; and
in step (d), using the flanges to couple the housing and ring and providing at least one shim located between the flanges for maintaining a selected distance between the flanges when the fasteners are tightened.
